(19) United States
(12) Patent Application Publication
(10) Pub. No.: US 2025/0030199 A1
(43) Pub. Date: Jan. 23, 2025

(54) ELECTRICAL CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: WEI-TA TSENG, New Taipei (TW); Jou-Tzu SHEN, New Taipei (TW)

(21) Appl. No.: 18/772,962

(22) Filed: Jul. 15, 2024

(30) Foreign Application Priority Data
Jul. 19, 2023 (CN) 202310887721.8

(51) Int. Cl. H01R 13/6471; H01R 13/6588; H01R 24/64; H01R 107/00

(52) U.S. Cl. CPC H01R 13/6471; H01R 13/6588; H01R 24/64; H01R 2107/00

(57) ABSTRACT

An electrical connector includes: a housing extending along a longitudinal direction; and a row of first terminals retained in the housing and including plural signal terminals and plural grounding terminals, each first terminal including a plate portion and a leg portion extending out of the housing, the plate portion defining an outer face exposed upon the housing and an inner face opposite the outer face, the outer face of the plate portion of the first terminal defining a mating face, wherein a transmission line is formed on the housing by laser direct structuring, and the transmission line is electrically connected to plural ground terminals to connect plural ground terminals in series.

### BACKGROUND OF THE INVENTION

### 1. Field of the Invention

The present invention relates to an electrical connector having a mating block arranged with a laser direct structuring (LDS) transmission line for contacting grounding terminals.

### 2. Description of Related Arts

Many electrical connectors include signal terminals and ground terminals in which the signal terminals convey data signals and the ground terminals reduce crosstalk and/or electromagnetic interference (EMI) between the signal terminals. In differential signaling applications, the signal terminals are arranged in signal pairs for carrying the data signals.

To address grounding resonance issue with a higher and higher signal-transmitting application, U.S. Pat. No. 10,777,921 discloses a conductive plastic bar to connect all grounding terminals together.

An improved electrical connector is desired.

### SUMMARY OF THE INVENTION

An object of the present invention is to provide an electrical connector having a housing with an LDS transmission line.

In order to achieve above-mentioned object, an electrical connector comprises: a housing extending along a longitudinal direction; and a row of first terminals retained in the housing and comprising plural signal terminals and plural grounding terminals, each first terminal comprising a plate portion and a leg portion extending out of the housing, the plate portion defining an exposed outer face exposed upon the housing and an inner face opposite the outer face, the outer face defining a mating face, wherein an LDS transmission line is formed on the housing, the transmission line is electrically connected to the plural ground terminals in series, the transmission line includes plural grounding lines corresponding to the plural grounding terminals and plural connecting lines each connecting two adjacent grounding lines to each other, the grounding terminals abut against the grounding lines, and the connecting lines are spaced apart from the signal terminals in a transverse direction perpendicular to the longitudinal direction.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a top perspective view of an electrical connector in accordance with the present invention;

FIG. 2 is a bottom perspective view of the electrical connector of FIG. 1;

FIG. 3 is an exploded perspective view of the electrical connector of FIG. 1;

FIG. 4 is another exploded perspective view of the electrical connector of FIG. 3 without the metallic shell;

FIG. 5 is an exploded perspective view of the electrical connector of FIG. 3 without the metallic shell and the housing block;

FIG. 6 is another exploded perspective view of the electrical connector of FIG. 5;

FIG. 7 is a top perspective view of the base block of FIG. 5;

FIG. 8 is a top perspective view of the electrical connector of FIG. 3 without the metallic shell, the housing block and the covering block;

FIG. 9 is a cross-sectional view of the electrical connector taken along line 9-9 in FIG. 1; and

FIG. 10 is a cross-sectional view of the electrical connector taken along line 10-10 in FIG. 1.

### DETAILED DESCRIPTION OF THE PREFERRED EMBODIMENT

Reference will now be made to the drawing figures to describe the preferred embodiment of the present invention in detail.

An electrical connector 100 of an embodiment of this present invention installed on a circuit board (not shown) for transmitting high-speed signals.

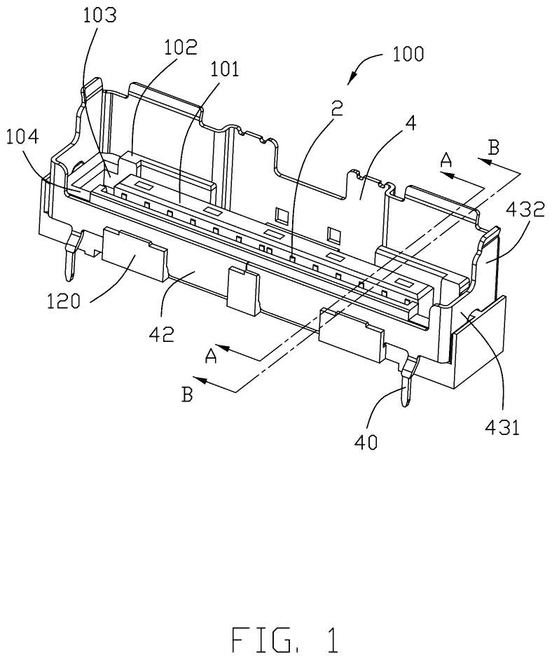

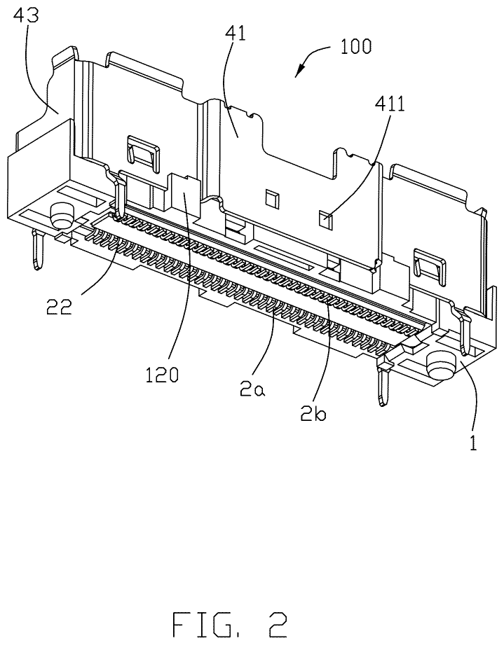

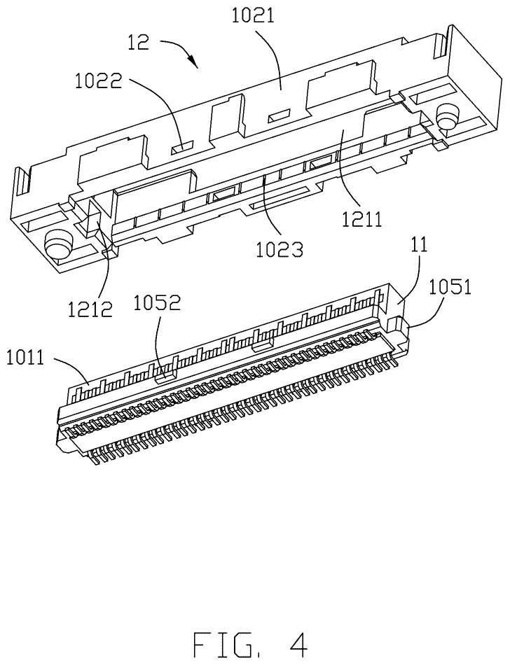

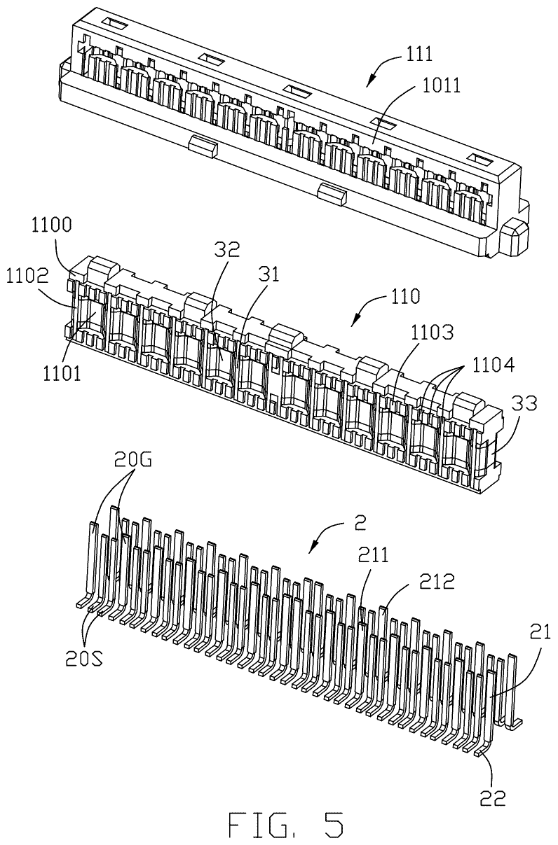

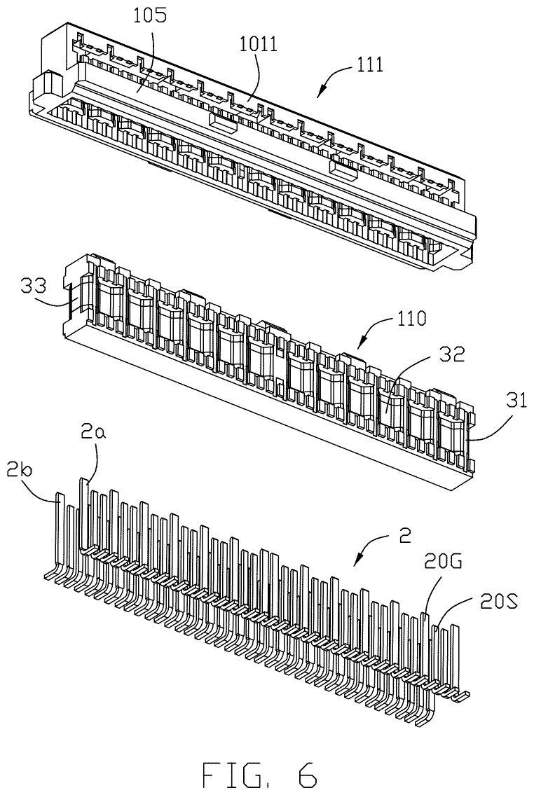

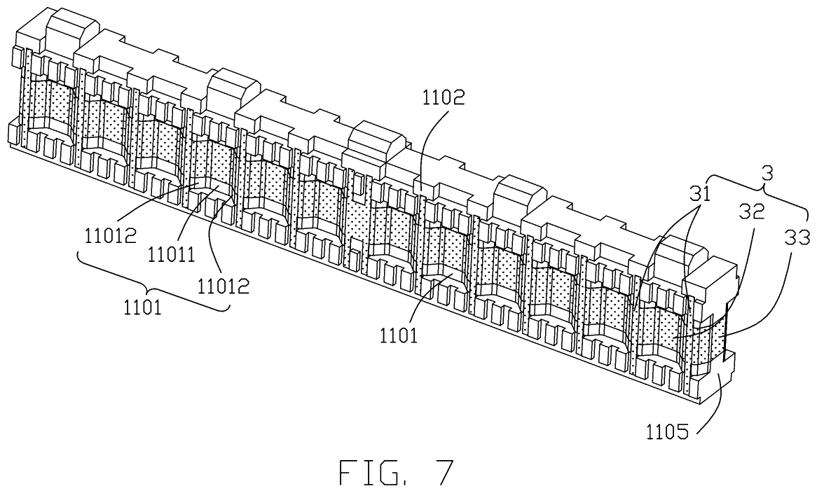

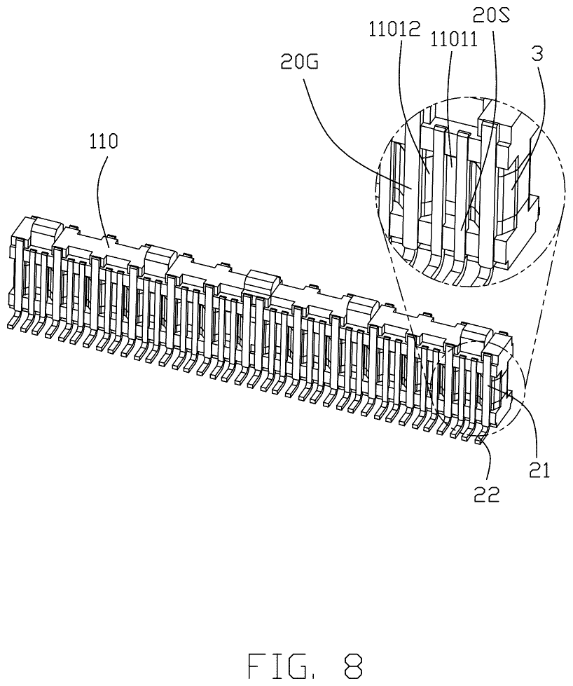

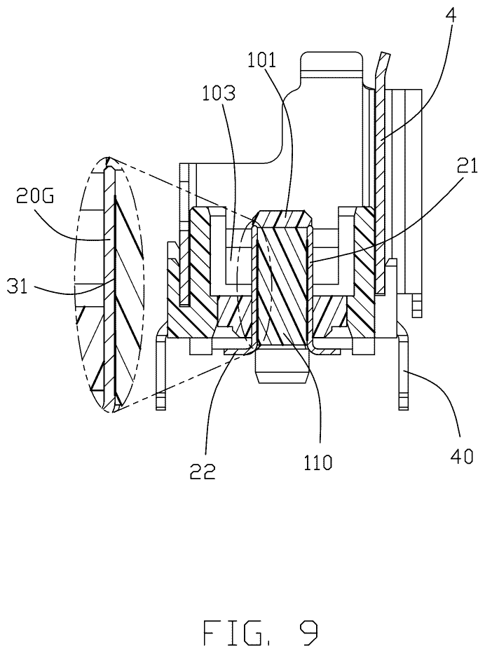

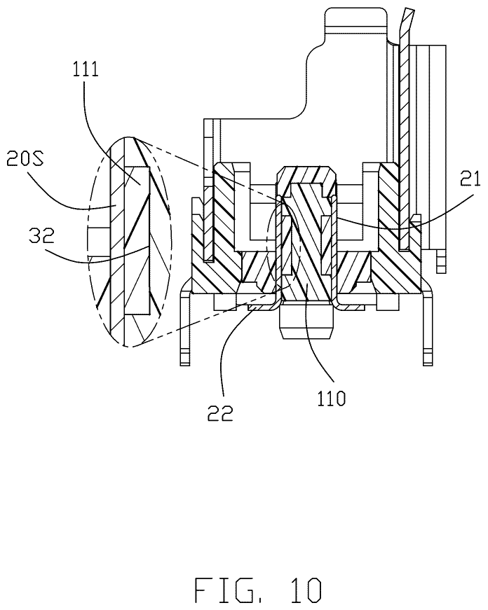

FIGS. 1-11 illustrate the electrical connector 100, the electrical connector 100 includes a housing 1 extending in a longitudinal direction, terminals 2 made from a metal plate and retained in the housing 1, a transmission line 3 formed on the housing 1 by laser direct structuring, and a metallic shell 4. In this embodiment, the terminals 20 include a row of first terminals 20a arranged along the longitudinal direction and a row of second terminals 20b opposite to the row of first terminals in a transverse direction. The housing 1 includes a mating tongue 101 and a frame portion 102 surrounding the mating tongue 101, commonly defining a mating cavity 103 between the mating tongue 101 and the frame portion 102, the mating cavity 103 runs through a mating face 104 defined on the housing 1. The metallic shell 4 is attached an outside of the frame portion 102 and protrudes upward beyond the mating face 104. A first side plate 41 of the metallic shell 4 defines two locking holes 411 for engaging with a plug connector (not shown). A second side plate 42 is substantially flush with the mating face 104 and have a top edge lower than that of the first side plate 41. Two end plates 43 is of a step shape, each includes a first taller portion 431 and a second taller portion 432 extending beyond the mating face 104, the second taller portion 432 is substantial flushed with the first side plate 41 and higher than the first taller portion 431. Parts of the first taller portions 431 extend to the second side plate 42. A plurality of guiding tabs 44 extends upwards from the first side plate 41 and the second taller portion 432. Understandingly, the step portion of the metallic shell 4 provides an improved guiding performance during an engagement of the two connectors, and an improved enforced balance of two connectors. The housing 1 defines retaining portions 120 with slits, the metallic shell 4 seats in the slits for fitly retaining the metallic shell 4 on the housing 1. The lower ends of the first side plate 41 and the second side plate 42 extend downward to form soldering feet 40, and the soldering feet 40 are soldered to the circuit board (not shown).

The housing 1 includes a mating block 11 and a housing block 12 assembled together, the mating block 11 includes the mating tongue 101 and a mounting portion 105 below the mating tongue 101, the housing block 12 includes a board portion 121 with a mounting opening 1211 and the frame portion 102. The mating block 11 is assembled through the mounting opening 1211 from a bottom end of the housing block 12, and the mounting portion 105 is fitly retained in the mounting opening 1211, thereby forming the housing 1. The mounting portion 105 defines two retaining lumps 1051 at opposite ends thereof, the board portion 121 defines recesses 1212 at a bottom face thereof. The retaining lumps 1051 are retained in the recesses 1212. Please notes, the recesses 1212 do not go upwards through the board portion 121, for limiting an upward movement of the mating block 11. The mounting portion 105 defines block portions 1052 at opposite sides thereof, two side walls 1021 of the frame portion 102 defines holding holes 1022 thereof. The block portions 1052 are received in the holding holes 1022. In addition, the inner wall surface of the side wall 1021 defines plural convex ribs 1023, and the convex ribs 1023 are used for interference fit with opposite sides of the mounting portion 105. In this embodiment, the two rows of terminals 2 are retained in the opposite sides of the mating block 11.

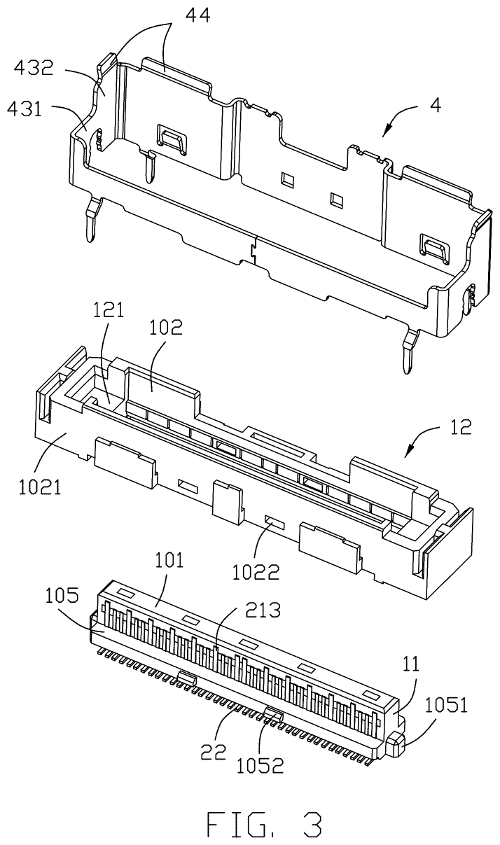

The terminals 2 includes plate portions 21 and leg portions 22 extending from the plate portions 21 out of the housing 1, the plate portion 21 defines an inner face 212 and an outer face 211 exposed upon mating surfaces 1011 of the mating tongue 101 and functioned as a mating face or portion 213 as shown in FIG. 3. Each row of the terminals 2 at least includes a signal terminal 20S and a grounding terminal 20G, in this embodiment two adjacent signal terminal 20S are construed as a pair of differential signal terminals, the grounding terminals 20G and the pairs of differential signal terminals alternate one by one. Each pair of differential signal terminals is sandwiched between two grounding terminals 20G at opposite sides thereof. The plate portions 21 of the grounding terminal 20G are longer than that of the signal terminals 20S and wider than that of the signal terminals.

The mating block 11 includes a base block 110 and a covering block 111, the opposite sides of the covering block 111 in the transverse direction form the mating surfaces 1011 of the mating tongue 101. The row of first terminals and the row of second terminals are retained in the opposite sides of the base block 110, and the covering block 111 is inserted molded with the base block 110 for retaining the two rows of terminals 2. The base block 110 includes concave surfaces 1101 and convex surfaces 1102 formed on side surfaces 1100 on opposite sides of the base block 110, and the concave surfaces 1101 and the convex surfaces 1102 alternate one by one. The upper and lower sides of the opposite side surfaces 1100 of the base block 110 protrude to form a plurality of protrusions 1103, and a positioning groove 1104 is formed between adjacent protrusions 1103 in the longitudinal direction for fixing the plate portion 21 of the two rows of terminals 2. The transmission line 3 is formed on opposite side surfaces 1100 of the base block 110 by laser direct structuring. The transmission line 3 includes grounding lines 31 corresponding to the plurality of grounding terminals 20G and connecting lines 32 corresponding to the signal terminal 20G which connecting adjacent grounding lines 31 to each other. The grounding lines 31 are formed on the convex surfaces 1102, and the connecting lines 32 are formed on the concave surfaces 1101. The convex surfaces 1102 are provided with the grounding lines 31 abutting the grounding terminals 20G, and the concave surfaces 1101 are provided with the connecting lines 32 to avoid the signal terminals 20S. When the plate portion 21 of the first row of terminals 2a and the second row of terminals 2b are fixed in the positioning groove 1104, the inner surface 212 of the plate portion 21 of the grounding terminal 20G abuts against the grounding line 31, and the inner surface 212 of the plate portion 21 of the signal terminal 20S is separated from the connecting line 32 via the concave surfaces 1101.

The transmission lines 3 on opposite sides of the base block 110 are arranged continuously and uninterruptedly. The grounding terminals 20G are connected in series with each other through the grounding lines 31 connected to each other. The transmission lines 3 can act as a metal layer to reduce the signal interference between the two rows of terminals 2. In this embodiment, the electrical connector 100 further includes an extension line 33, which is formed on end surfaces 1105 on opposite ends of the longitudinal direction of the base block 110, and the extension line 33 connects the transmission lines 3 on the opposite side surfaces 1100 of the base block 110 to each other to form a closed loop line to improve high frequency performance.

The concave surface 1101 defines a bottom surface 11011 and inclined surfaces 11012 locating on opposite sides of the bottom surface 11011 in the longitudinal direction, and the convex surface 1102 and the bottom surface 11011 are both planes. The bottom surface 11011 is connected to the inclined surface 11012 by an arc, and the inclined surface 11012 is connected to the convex surface 1102 by an arc. The width of the bottom surface 11011 and the pair of differential signal terminals 20S is roughly the same. The concave depth of the side concave surface 1101 can be used to adjust the spacing between the connecting lines 32 and the signal terminal 20S, thereby improving the high frequency performance of the electrical connector 100.

A method of making the electrical connector 100 comprises: providing the insulative base block 110 and forming the transmission line 3 on opposite sides of the insulating base block by laser direct structuring, wherein the transmission line 3 includes grounding line 31 corresponding to the convex surface 1102 and connecting line 32 corresponding to the concave surface 1101; providing two rows of terminals 2 to be fixed to the base block 110, wherein the grounding terminal 20G abuts against the grounding line 31; insert molding the covering block 111 with the base block 110 and forming the mating block 11; providing a housing block 12 and assembling the mating block 11 in the housing block 12 to form the insulating 1; providing the metal shell 4 to surround the housing block 12 to form the electrical connector 100.

Although the present invention has been described with reference to particular embodiments, it is not to be construed as being limited thereto. Various alterations and modifications can be made to the embodiments without in any way departing from the scope or spirit of the present invention as defined in the appended claims.

1. An electrical connector comprising:
a housing extending along a longitudinal direction; and
a row of first terminals retained in the housing and comprising plural signal terminals and plural grounding terminals, each first terminal comprising a plate portion and a leg portion extending out of the housing, the plate portion defining an exposed outer face exposed upon the housing and an inner face opposite the outer face, the outer face defining a mating face;
wherein a transmission line is formed on the housing by laser direct structuring, the transmission line is electrically connected to the plural ground terminals in series, the transmission line includes plural grounding lines corresponding to the plural grounding terminals and plural connecting lines each connecting two adjacent grounding lines to each other, the grounding terminals abut against the grounding lines, and the connecting lines are spaced apart from the signal terminals in a transverse direction perpendicular to the longitudinal direction.

2. The electrical connector as claimed in claim 1, further comprising a row of second terminals opposite to the row of first terminals, wherein a plurality of grounding terminals of the row of second terminals abut against the grounding lines, and a plurality of signal terminals of the row of second terminals are spaced apart from the connecting lines.

3. The electrical connector as claimed in claim 2, wherein the housing comprises a mating block having a mating tongue and a mounting portion and a housing block having a board portion with a mounting opening and a frame portion, the mounting portion of the mating block is retained in the mounting opening and the mating tongue is surrounded by the frame portion to define a mating cavity between the mating tongue and the frame portion, and the mating faces of the two rows of terminals are arranged along the mating tongue.

4. The electrical connector as claimed in claim 3, wherein the mating block defines a base block and a covering block insert molded with the base block, the transmission line is formed on opposite sides of the base block in the transverse direction by laser direct structuring, the opposite sides of the base block define plural concave surfaces and plural convex surfaces, the plural convex surfaces are provided with the grounding lines abutting the grounding terminals, and the plural concave surfaces are provided with the connecting lines spaced from the signal terminals.

5. The electrical connector as claimed in claim 4, wherein the opposite surfaces of the base block in the transverse direction protrude to form a plurality of protrusions arranged in the longitudinal direction, and a respective positioning groove is formed between two adjacent protrusions in the longitudinal direction to fix a corresponding terminal, and the grounding lines are provided in the positioning grooves corresponding to the grounding terminals.

6. The electrical connector as claimed in claim 4, wherein the inner surface of the grounding terminal abuts against the grounding line, and the inner surface of the signal terminal is spaced apart from the connecting line in the transverse direction.

7. The electrical connector as claimed in claim 4, wherein electrical connector further includes extension lines formed on opposite end surfaces of the base block to connect the transmission lines on opposite side surfaces of the base block to each other.

8. The electrical connector as claimed in claim 4, wherein the concave surfaces and the convex surfaces alternate one by one, the concave surface defines a bottom surface and inclined surfaces locating on opposite sides of the bottom surface in the longitudinal direction, the convex surface and the bottom surface are both planar.

9. The electrical connector as claimed in claim 8, wherein two adjacent signal terminals form a pair of differential signal terminals in each row of terminals, the grounding terminals and the pairs of differential signal terminals alternate one by one, a width of the bottom surface is substantially equal to an outer dimension of a pair of differential signal terminals.

10. The electrical connector as claimed in claim 2, wherein the transmission line is arranged continuously and uninterruptedly in the longitudinal direction, and the row of first terminals and the row of second terminals are located within a longitudinal range of the transmission line in the longitudinal direction.
